(19) United States
(12) Patent Application Publication
(10) Pub. No.: US 2014/0089739 A1
(43) Pub. Date: Mar. 27, 2014

(54) SERIAL ADVANCED TECHNOLOGY ATTACHMENT DUAL IN-LINE MEMORY MODULE DEVICE HAVING TESTING CIRCUIT FOR CAPACITOR

(71) Applicants: XIAO-GANG YIN, Shenzhen City (CN); GUO-YI CHEN, Shenzhen City (CN)

(72) Inventors: XIAO-GANG YIN, Shenzhen City (CN); GUO-YI CHEN, Shenzhen City (CN)

(21) Appl. No.: 13/663,639

(22) Filed: Oct. 30, 2012

(30) Foreign Application Priority Data
Sep. 27, 2012 (CN) 2012103733607

(51) Int. Cl. G06F 11/27

(52) U.S. Cl. 714/42; 714/E11.169

(57) ABSTRACT

A serial advanced technology attachment dual in-line memory module device includes a capacitor to be tested, a control chip, a display device, a testing chip, and a selecting chip. Voltage pins of the testing chip and the selecting chip are connected to a power source. A testing pin of the testing chip is connected to the capacitor. A first input output (I/O) pin of the selecting chip is connected to a first I/O pin of the testing chip. A second I/O pin of the selecting chip is connected to a second I/O pin of the testing chip. A third I/O pin of the selecting chip is connected to an input pin of the control chip. A fourth I/O pin of the selecting chip is connected to an output pin of the control chip. A fifth I/O pin of the selecting chip is connected to the display device.

### BACKGROUND

1. Technical Field

The present disclosure relates to serial advanced technology attachment dual in-line memory module (SATA DIMM) devices, and particularly to a SATA DIMM device having a testing circuit for a capacitor.

2. Description of Related Art

Solid state drives (SSD) store data on chips instead of on magnetic or optical discs. One type of SSD has the form factor of a DIMM module and is called a SATA DIMM module. The SATA DIMM module can be inserted into a memory slot of a motherboard, to receive voltages from the motherboard through the memory slot and receive hard disk drive (HDD) signals through SATA connectors arranged on the SATA DIMM module and connected to a SATA connector of the motherboard. However, the SATA DIMM device may lose data when the motherboard is powered off abnormally.

Super capacitors, as power down protection elements, are employed in the SATA DIMM module power supply systems. When a main power supply to the SSD is turned off accidentally, the super capacitor will maintain a supply of power, so that the SSDs have time to save data. However, if the super capacitor has inherent defects, the reliability of the SSD is effectively non-existent.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIGS. 1 and 2 are circuit diagrams of a serial advanced technology attachment dual in-line memory module device having testing circuit for capacitor in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

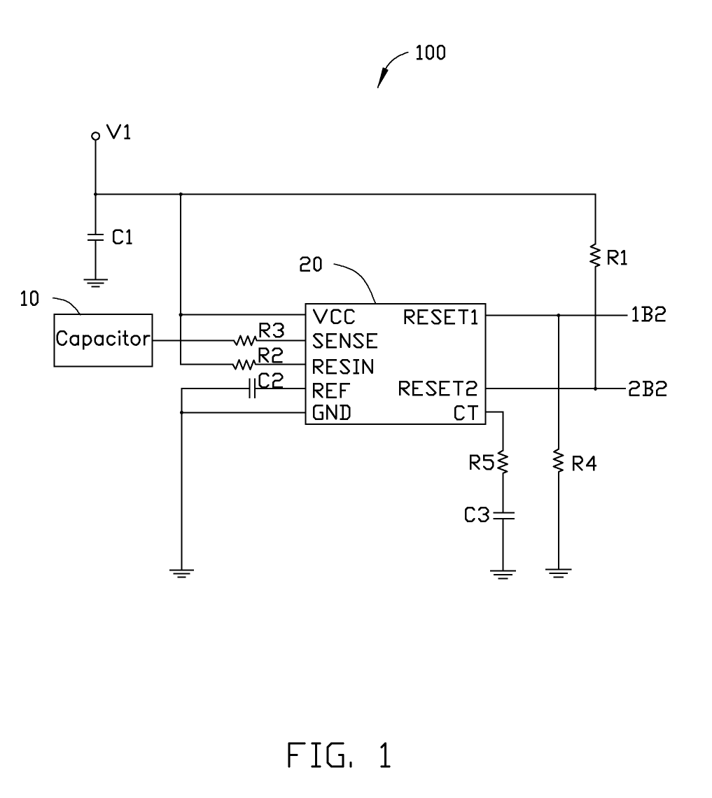

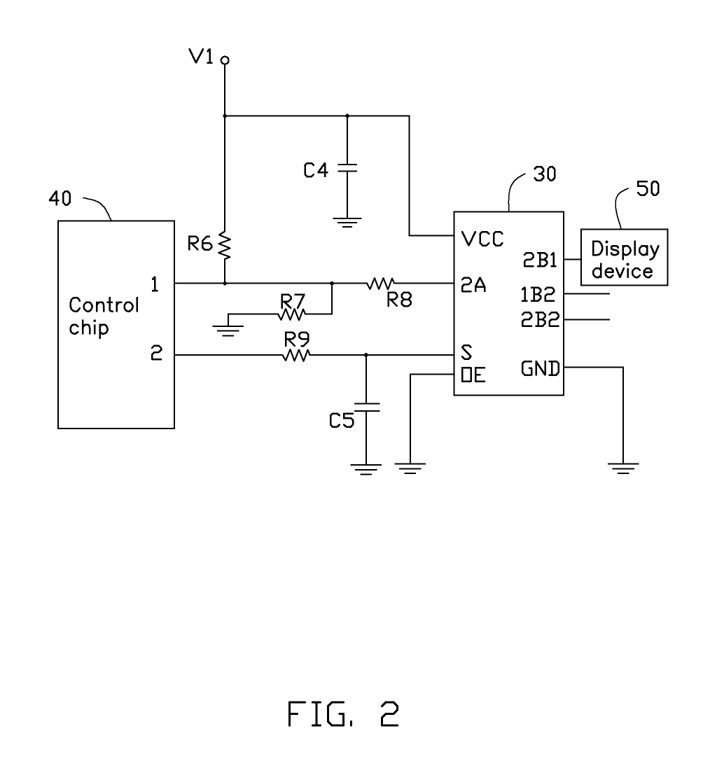

FIGS. 1 and 2 show a serial advanced technology attachment dual in-line memory module (SATA DIMM) device 100 of one embodiment. The SATA DIMM device 100 includes resistors R1-R9, capacitors C1-C5, a capacitor 10 to be tested, a testing chip 20 to store a preset voltage, a selecting chip 30, a control chip 40, and a display device 50, such as a light emitting diode (LED). Other elements of the SATA DIMM device 100 are known to those skilled in the art of SATA DIMM devices.

A voltage pin VCC of the testing chip 20 is connected to a power source V1 and also grounded through the capacitor C1. An input output (I/O) pin RESET2 of the testing chip 20 is connected to the voltage pin VCC of the testing chip 20 through the resistor R1 and also connected to an I/O pin 2B2 of the selecting chip 30. An I/O pin RESET1 of the testing chip 20 is grounded through the resistor R4 and also connected to an I/O pin 1B2 of the selecting chip 30. An I/O pin CT of the testing chip 20 is grounded through the resistor R5 and the capacitor C3 in sequence. The resistor R2 is connected between the voltage pin VCC of the testing chip 20 and an I/O pin RESIN of the testing chip 20. An I/O pin REF of the testing chip 20 is grounded through the capacitor C2. A testing pin SENSE of the testing chip 20 is connected to the capacitor 10 through the resistor R3. A ground pin GND of the testing chip 20 is grounded. A voltage pin VCC of the selecting chip 30 is connected to the power source V1 and also grounded through the capacitor C4. An I/O pin 2A of the selecting chip 30 is connected to an input pin 1 of the control chip 40 through the resistor R8. The resistor R6 is connected between the power source V1 and the input pin 1 of the control chip 40. The resistor R7 is connected between the input pin 1 of the control chip 40 and ground. An I/O pin S of the selecting chip 30 is connected to an output pin 2 of the control chip 40 through the resistor R9. The capacitor C5 is connected between the I/O pin S of the selecting chip 30 and ground. An I/O pin 2B1 of the selecting chip 30 is connected to the display device 50.

In use, when the SATA DIMM device 100 is powered on, the control chip 40 outputs a high level signal to the I/O pin S of the selecting chip 30 through the output pin 2 of the control chip 40. The I/O pin S and the I/O pin 1B2 of the selecting chip 30 are connected together and outputs a high level signal to the testing chip 20. At the same time, the I/O pin 2A and the I/O pin 2B2 of the selecting chip 30 are connected together. The testing chip 20 receives the high level signal through the I/O pin 1B2, measures a voltage of the capacitor 10 through the testing pin SENSE, and compares the measured voltage with the preset voltage, such as 4 volts (V). If the measured voltage is equal to or greater than the preset voltage, the testing chip 20 outputs a testing pass signal to the control chip 40 through the I/O pin RESET2 of the testing chip 20, the I/O pin 2B2 of the selecting chip 30, and the I/O pin 2A of the selecting chip 30. The control chip 40 receives the testing pass signal and outputs a low level signal to the I/O pin S of the selecting chip 30 through the output pin 2 of the control chip 40. The I/O pin 2A and the I/O pin 2B1 of the selecting chip 30 are connected together. The control chip 40 controls the display device 50 to display a testing result, such as turning on the LED, to indicate that the capacitor 10 is qualified. If the SATA DIMM device 100 is powered off abnormally, the control chip 40 controls the capacitor 10 to discharge, to provide a voltage to the SATA DIMM device 100 and prevent the SATA DIMM device 100 from losing data.

If the measured voltage is less than the preset voltage, the testing chip 20 outputs a testing fail signal to the control chip 40 through the I/O pin RESET2, the I/O pin 2B2 of the selecting chip 30, and the I/O pin 2A of the selecting chip 30. The control chip 40 receives the testing fail signal and outputs a low level signal to the I/O pin S of the selecting chip 30 through the output pin 2 of the control chip 40. The I/O pin 2A and the I/O pin 2B1 of the selecting chip 30 are connected together. The control chip 40 controls the display device 50 to display a testing result, such as turning off the LED, to indicate that the capacitor 10 is unqualified.

The SATA DIMM device 100 can test the capacitor 10 by measuring a voltage of the capacitor 10 and comparing the measured voltage of the capacitor 10 with the preset voltage through the testing chip 20, the selecting chip 30, and the control chip 40, to determine whether the capacitor 10 is qualified or not. Therefore, the SATA DIMM device 100 can avoid losing data when the SATA DIMM device 100 is powered off abnormally and the capacitor 10 is unqualified.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A serial advanced technology attachment dual in-line memory module (SATA DIMM) device, comprising:
a capacitor;
a control chip;
a display device;
a testing chip storing a preset voltage, wherein a voltage pin of the testing chip is connected to a power source, a testing pin of the testing chip is connected to the capacitor; and
a selecting chip, wherein a voltage pin of the selecting chip is connected to the power source, a first input output (I/O) pin of the selecting chip is connected to a first I/O pin of the testing chip, a second I/O pin of the selecting chip is connected to a second I/O pin of the testing chip, a third I/O pin of the selecting chip is connected to an input pin of the control chip, a fourth I/O pin of the selecting chip is connected to an output pin of the control chip, a fifth I/O pin of the selecting chip is connected to the display device;
wherein when the SATA DIMM device is powered on, the control chip outputs a first signal to the fourth I/O pin of the selecting chip through the output pin of the control chip, the fourth I/O pin and the first I/O pin of the selecting chip are connected and output the first signal to the testing chip, the third I/O pin and the second I/O pin of the selecting chip are connected, the testing chip receives the first signal through the first I/O pin and measures a voltage of the capacitor through the testing pin and compares the measured voltage with the preset voltage, upon a condition that the testing voltage is equal to or greater than the preset voltage, the testing chip outputs a testing pass signal to the control chip through the second I/O pin of the testing chip, the second I/O pin of the selecting chip, and the third I/O pin of the selecting chip, the control chip receives the testing pass signal and outputs a second signal to the fourth I/O pin of the selecting chip through the output pin of the control chip, the third I/O pin of the selecting chip and the fifth I/O pin of the selecting chip are connected, the control chip controls the display device to display a testing result to show that the capacitor is qualified; upon a condition that the measured voltage is less than the preset voltage, the testing chip outputs a testing fail signal to the control chip through the second I/O pin of the testing chip, the second I/O pin of the selecting chip, and the third I/O pin of the selecting chip, the control chip receives the testing fail signal and outputs a third signal to the fourth I/O pin of the selecting chip through the output pin of the control chip, the third I/O pin and the fifth I/O pin of the selecting chip are connected, the control chip controls the display device to display a testing result to show that the capacitor is unqualified.

2. The SATA DIMM device of claim 1, further comprising first to ninth resistors, wherein the first resistor is connected between the second I/O pin of the testing chip and the voltage pin of the testing chip, the second resistor is connected between the third I/O pin of the testing chip and the voltage pin of the testing chip, the third resistor is connected between the testing pin of the testing chip and the capacitor to be tested, the fourth resistor is connected between the first I/O pin of the testing chip and ground, the fifth resistor is connected between the fifth I/O pin of the testing chip and ground, the sixth resistor is connected between the input pin of the control chip and the power source, the seventh resistor is connected between the input pin of the control chip and ground, the eighth resistor is connected between the third I/O pin of the selecting chip and the input pin of the control chip, the ninth resistor is connected between the output pin of the control chip and the fourth I/O pin of the selecting chip.

3. The SATA DIMM device of claim 1, further comprising first to fifth capacitors, wherein the first capacitor is connected between the voltage pin of the testing chip and ground, the second capacitor is connected between the fourth I/O pin of the testing chip and ground, the third capacitor is connected between the fifth resistor and ground, the fourth capacitor is connected between the voltage pin of the selecting chip and ground, the fifth capacitor is connected between the fourth I/O pin of the selecting chip and ground.
